(19) United States
(12) Patent Application Publication
(10) Pub. No.: US 2003/0118689 A1
(43) Pub. Date: Jun. 26, 2003

(54) Embossing system

(76) Inventors: Christopher Robert Carlson, Wausau, WI (US); Jamieson A. Foght, Middleton, WI (US); Robert W. Cornell, Schofield, WI (US)

Correspondence Address: FOLEY & LARDNER, 330 NORTH WABASH AVENUE, SUITE 3300, CHICAGO, IL, 60611-3608, US

(21) Appl. No.: 10/036,843

(22) Filed: Dec. 21, 2001

(51) Int. Cl. B29D 31/00; B31B 1/25; B26D 3/08

(52) U.S. Cl. 425/811; 83/879

(57) ABSTRACT

An embossing system comprising a base having a plurality of posts positioned on the outer portion thereof. A lower template includes a plurality of shapes formed therein and a plurality of regions on the outer portion thereof for alignment with the posts. A textured plate is positioned between the base and lower template, and an upper template includes a plurality of regions on the outer portion thereof for alignment with the posts and the regions of the lower template. A plurality of shapes are formed on the upper template. The shapes on the upper template align with the shapes of the lower template when the posts and the regions of the upper template and lower template are in alignment.

### FIELD OF THE INVENTION

The present invention relates generally to scoring or embossing systems. More particularly, the present invention relates to a system for scoring or embossing a variety of shapes onto materials such as paper and card stock.

### BACKGROUND OF THE INVENTION

Systems for embossing and describing different shapes and patterns are conventionally known. One embossing system involves placing a medium such as paper, card stock or metal foil on a table or a similar structure. A template with at least one shape formed therein is positioned atop the medium and is held in place either by an adhesive or the user's hand. The user traces the perimeter of the shape onto the medium with the use of a stylus. The template could also be used with a craft knife for cutting out the desired shape.

Another conventional embossing system involves the use of two identical and aligned templates, with both templates including identical shapes in the same position on each template. The medium is placed between the two templates, and a stylus is used to trace the shape onto the medium. An embosser including a ball bearing on the tip may also be used to trace the shape of the medium.

Although such embossing and scoring systems are generally known, conventional systems often suffer from a lack of control of the individual components. In particular, in many conventional systems the user must hold down the template or templates with one hand while scoring or embossing the shape with the other hand. In systems where the templates are clamped down, they are restrained using adhesives or similar devices which are difficult to set and reset over time.

### SUMMARY OF THE INVENTION

It is therefore an object of the invention to provide an improved embossing system that allows the user to fix the position of the individual components.

It is another object of the invention to provide an improved embossing system that permits a user to use both hands while embossing individual shapes, letters, numbers, or designs.

It is yet another object of the invention to provide an improved embossing system that permits a user to change individual templates quickly.

It is another object of the invention to provide an improved embossing system that permits a user to quickly change the individual textures that are embossed on the medium.

It is another object of the invention to provide an improved embossing system that includes detachable components for fixing the position of the embossing templates.

In accordance with the above objects, the present invention provides for an embossing system including a set of matched templates with a plurality of openings that describe the geometry created during the embossing. The templates are aligned and fixed on a base plate using a plurality of alignment pegs, and a textured plate is positioned below the templates for imparting a particular texture on the embossed medium.

Further advantages and features of the present invention will be apparent from the following specification, drawings and claims illustrating the preferred embodiments of the present invention.

### BRIEF DESCRIPTION OF THE DRAWINGS

FIG. 1A is an exploded view of an embossing system according to one embodiment of the present invention; and FIG. 1B is an exploded view of an embossing system according to another embodiment of the present invention;

FIG. 2 is a perspective view of an embossing system according to an alternate embodiment of the invention; and

FIG. 3 is a perspective view of an embossing system according to yet another embodiment of the invention.

### DETAILED DESCRIPTION OF PREFERRED EMBODIMENTS

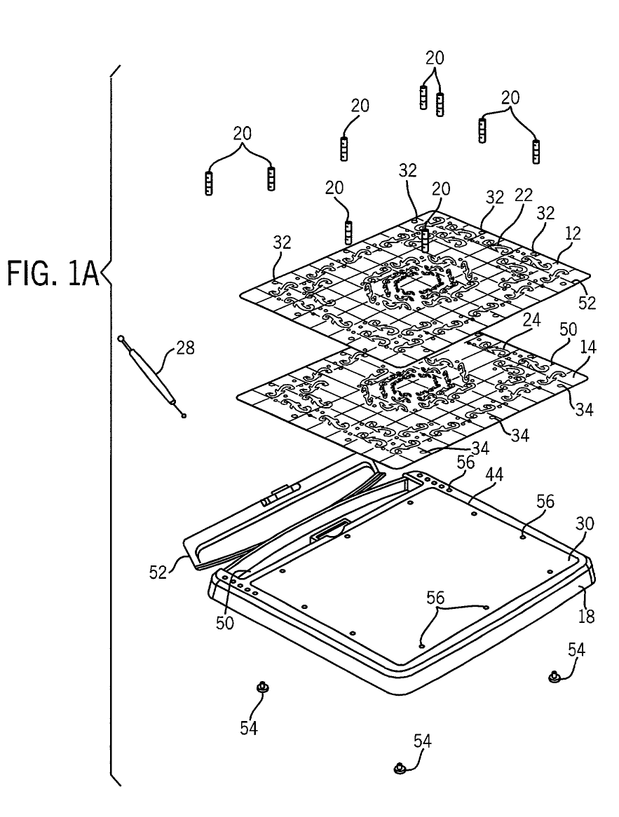

An embossing system 10 constructed in accordance with the invention is generally shown in FIGS. 1A-3. The embossing system 10 includes an upper template 12 and a lower template 14. In one embodiment of the invention and as shown in FIG. 1B, a textured plate 16 is positioned generally below the lower template 14. The textured plate 16 may include a variety of textured surfaces that may include grooves, ridges, undulations, or other textures. Alternatively, the textured plate 16 may include no texture at all depending upon the user's specific needs. The upper template 12, the lower template 14 and the textured plate 16 are all removably positioned on top of a base plate 18.

The upper template 12 includes a plurality of upper template shapes 22. The upper template shapes 22 may vary greatly and could also include, for example, lettering, numbering or other designs. The lower template 14 includes a plurality of lower template shapes 24. The lower template shapes 24 may also vary but are substantially identical in both shape, size and position to the upper template shapes 22 on the upper template 12. In other words, the lower template shape 24 at a particular position on the lower template 14 is substantially identical to the upper template shape 22 at the same position on the upper template 12.

In a preferred embodiment of the invention, the upper template shapes 22, although identical to the corresponding lower template shapes 24, are slightly larger than the corresponding lower template shapes 24. The slight different in sizes between the upper template shapes 22 and the corresponding lower template shapes 24 permit a user to make an improved, more crisp embossment along the edge of the shape to be embossed. In one particular embodiment of the invention, each upper template shape is about 0.050 larger in cross-section than the corresponding lower template shape 24.

The upper template 12, the lower template 14 and the textured plate 16 are all sized to fit on top of the base plate 18 in a close fitting relationship. As shown in FIG. 1B, the base plate 18, according to one embodiment of the invention, includes a small depression 30 which is sized such that the textured plate 16 and/or the upper template 22 and the lower template 24 fit therein.

According to a preferred embodiment of the invention, the upper template 12 and the lower template 14 matingly engage the base plate 18. This engagement is accomplished through the use of removable alignment pegs 20 positioned on the base plate 18 and corresponding upper template holes 32 and lower template holes 34, along with a plurality of base plate holes 56 located along the base plate 18. The alignment pegs 20 and the base plate holes 56 are positioned along an outer edge 44 of the base plate 18. It is also possible to have additional ones of the base plate holes 56 on the sides of the base plate 18 for storage purposes, as shown in FIG. 1A.

For each one of the alignment pegs 20, there is an upper template hole 32 and a lower template hole 34 located in an identical position on the upper template 12 and the lower template 14, respectively. The upper template holes 32 and lower template holes 34 are sized to closely fit with the alignment pegs 20 on the base plate 18. When the upper template holes 32, the lower template holes 34 and the alignment pegs 20 are in a mating engagement, the upper template 12 and the lower template 14 are impeded from moving relative to the base plate 18. This feature greatly aids the user in operating the embossing system 10 without the risk of inadvertent movement of the upper template 12 or the lower template 14. Additionally, this arrangement permits the upper template 12 and the lower template 14 from being completely removed from the base plate 18. This permits the user to use different types of templates on the same base plate 18, while also allowing the user to change the textured plate 16 depending upon the particular user needs.

According to one embodiment of the invention, the individual alignment pegs 20 are removable such that the user is able to use larger pieces of paper or other oversized mediums without bending the medium when a medium 26 is disposed inside the embossing system 10. This arrangement also permits the user of other templates of varying sizes which may or may not be provided with the embossing system 10 of the present invention.

In one embodiment of the invention, the embossing system 10 includes a storage compartment 50 with a lid 52. The storage compartment 50 and the lid 52 may be used to store a stylus 28, other marking instruments and/or the alignment pegs 20. A variety of types of locking mechanisms may be used to secure the lid 52, enclosing the storage compartment 50.

The overall size of the embossing system 10 may vary depending upon the particular user requirements. In one embodiment of the invention, the embossing system 10 will be of a size to correspond to standard 8½″ by 11″ paper. Alternatively, the embossing system 10 could be sized to better fit standard greeting cards or other paper items. The embossing system may include a plurality of feet 54 coupled to the underside of the base plate 18. The feet 54, which may be formed from rubber or other materials, prevent or impede the base plate 18 from sliding along the surface upon which the embossing system 10 is placed.

The upper template 12 and the lower template 14, according to one embodiment of the invention, are made of PET or biaxially oriented film or mylar and can be transparent and/or tinted. The upper template 12 may include a preprinted upper template grid 52, and the lower template 14 may include a preprinted lower template grid 50. The upper template grid 52 and the lower template grid 50 may be used for properly aligning the medium 26. The embossing system 10 may also include a self-healing cutting mat (not shown). The thickness of the upper template 12 and the lower template 14 may vary depending upon the particular use.

In a preferred embodiment of the invention, the lower template 14 has a thickness of about 0.010-0.020 inches and is formed from an opaque, colored plastic material. In a most preferred embodiment of the invention, the lower template 14 has a thickness of about 0.010 inches. It has been observed that when the lower template 14 has a thickness of about 0.010 inches, the medium is less likely to be torn during the embossing process than when the lower template 14 has a greater thickness. In a most preferred embodiment of the invention, the upper template 12 has a greater thickness than the lower template, and it has been found that there is improved quality in the embossment when the upper template 12 and the lower template 14 have different thicknesses. In a preferred embodiment of the invention, the upper template has a thickness of about 0.015-0.020 inches, with a most preferred thickness of about 0.015 inches. Other thicknesses for the upper template 12 and the lower template 14 may be used, and it is also possible for the upper template 12 and the lower template 14 to be of substantially identical thicknesses.

The upper template 12 and the lower template 14 may be laser cut, water jet cut, die cut, or punched out of sheet material. In one particular embodiment of the invention, the base plate 18 is injection molded.

The embossing system 10 includes the stylus 28 or similar marking mechanism for embossing or scoring the medium 26. A variety of types of marking mechanisms may be used. One exemplary form of marking device includes a ball bearing at one end thereof. One such device is currently marketed under the name EMPRESSOR™ Alternatively, a pencil or other drawing instrument could be used in place of the stylus 28. The embossing system 10 can be used on a variety of the medium including without limitation paper, card stock, bond paper, thirty pound vellum, metal foil, and other such materials.

The operation of the embossing system 10 is generally as follows. When a user desires to emboss a particular material, the user first selects the proper textured plate 16 and locates the selected textured plate 16 within the depression 30 of the base plate 18. The user selects the particular shape to be embossed on the material, and places the lower template 14 containing that shape atop the base plate 18, aligning the lower template holes 34 with the alignment pegs 20. The user then positions the medium 26 on top of the lower template 14 in such a position as to cover the particular shape to be scored. Once the medium 26 is in a proper position, the user locates the upper template 12 on top of the medium 26 and the lower template 14, aligning the upper template holes 32 with the alignment pegs 20. The user maneuvers the stylus 28 within the particular upper template shape 22 which is to be embossed on the material 26. During this process, the user may maneuver the stylus 28 along only the outer edge of the upper template shape 22, or may maneuver it throughout the region. When the user is done maneuvering or scoring the upper template shapes 22, the user removes the upper template 12. The material 26 then includes an embossment corresponding to the upper template shape 22 and the lower template shape 24.

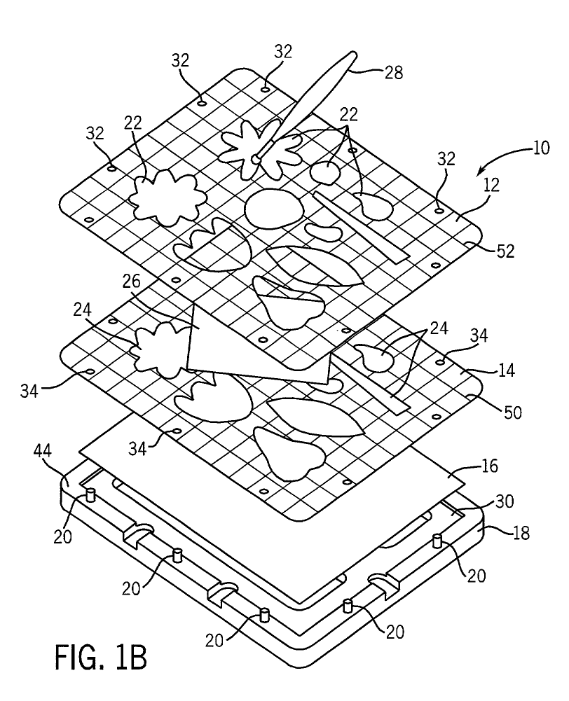

According to an alternate embodiment of the invention and as shown in FIG. 2, the upper template 12 and the lower template 14 can be a variety of shapes and may also only include the upper template holes 32 and the lower template holes 34 on an upper template margin 36 and a lower template margin 38, respectively. Although the positioning of the individual upper template holes 32 and the lower template holes 34 can vary, the upper template holes 32 and the lower template holes 34 still operate to fix the position of the upper template 12 and lower template 14 so long as they mate with the alignment pegs 20 on the base plate 18. In one embodiment of the invention, the upper template holes 32 and the lower template holes 34 are positioned to align with the standard European and/or American binder hole arrangements.

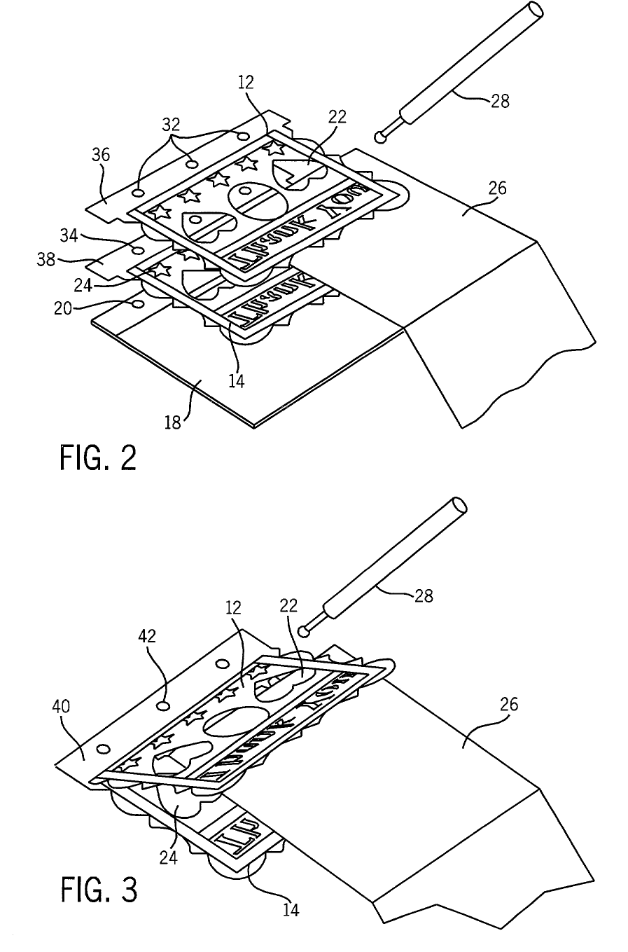

In still another embodiment of the invention, and as shown in FIG. 3, the upper template 12 and the lower template 14 are joined together at a single margin 40 that includes margin alignment holes 42. The single margin 40 provides the user the added benefit of keeping the upper template 12 and the lower template 14 together at all times, minimizing the risk of at least one of the upper template 12 or the lower template 14 being lost. In this particular embodiment of the invention, the upper template 12 and the lower template 14 are hingedly or flexedly connected to each other such that the medium 26 can be easily positioned and removed from the embossing system 10.

In yet another embodiment of the invention, an integrated clamp (not shown) may be used to further clamp the individual components of the embossing system 10 in place. For example, the integrated clamp can be used as a ruler for measuring and alignment of the medium 26 or other items in the embossing system 10. The clamp can be spring tensioned to hold the individual components securely in place.

The embossing system 10 may also include a storage lid (not shown) sized to fit on top of the upper and the lower templates 12 and 14, the textured plate 16 and the base plate 18, mating with the alignment pegs 20 to safely secure all of the components. Additionally, a small light (not shown) may be positioned inside the depression 30. The light may be used to illuminate the material 26 being embossed, making it easier for the user to identify whether the material 26 has been embossed and, if so, the degree of embossment.

Additionally, in one embodiment of the invention the embossing system could be shaped and sized to operate with a shape cutting system of the type described in U.S. patent application Ser. No. 09/769,683, filed on Jan. 25, 2001 and incorporated herein by reference. In this particular embodiment, the shape cutting device and associated materials are operated on the top of the base plate 18. The alignment pegs 20 may also be of a sufficient height such that multiple templates and scoring guides from the shape cutting system could be stored with the embossing system 10, resulting in a significant space savings.

While preferred embodiments of the invention have been shown and described, it will be clear to those skilled in the art, that potential modifications can be made to the embodiments described above. For example, a variety of coupling mechanisms other than the alignment pegs 20 may be used to secure the upper and lower templates 12 and 14 to the base plate 18. Alternatively, it is possible to have the textured plate 16 mate with the alignment pegs 20 of the base plate 18. It will therefore be well understood by those in the art that modifications can be made to the above embodiments without departing from the invention in its broader aspects.

1. An embossing system, comprising:
a base including a plurality of posts positioned on an outer portion thereof;
a lower template including:
a plurality of shapes formed therein, and
a plurality of regions on the outer portion thereof for alignment with the posts;
an upper template including:
a plurality of regions on the outer portion thereof for alignment with the posts and the regions of the lower template, and
a plurality of shapes formed therein that align with the shapes of the lower template when the posts and the regions of the upper template and the lower template are in alignment, the plurality of shapes being smaller in size than the corresponding plurality of regions.

2. The embossing system of claim 1, further comprising a textured plate positioned between the base and lower template.

3. The embossing system of claim 1, further comprising a scoring tool of a size to fit within the shapes of the upper template and the lower template.

4. The embossing system of claim 3, wherein the upper template and the lower template are removably connected to the base.

5. The embossing system of claim 4, wherein the textured plate is removable from the base.

6. The embossing system of claim 4, wherein the upper template and the lower template are hingedly coupled to each other.

7. The embossing system of claim 4, wherein the base includes a depressed portion for accepting the lower template.

8. The embossing system of claim 1, wherein the upper template is of a different thickness than the lower template.

9. The embossing system of claim 1, wherein the lower template has a thickness of about 0.010 inches.

10. The embossing system of claim 1, wherein the upper template includes a preprinted grid for aligning the material to be embossed.

11. The embossing system of claim 10, wherein the lower template includes a preprinted grid for aligning the material to be embossed.

12. A device for scoring materials, comprising:
first and second substantially identical templates;
a base;
a textured plate positioned between the base and the first template; and
means for coupling the first template and the second template to the base.

13. The device of claim 12, wherein the first template and the second template include a plurality of grooves formed therein.

14. The device of claim 13, wherein the base includes a depression for accepting and positioning the textured plate.

15. The device of claim 14, further comprising a stylus for scoring materials placed between the first template and the second template.

16. The device of claim 12, wherein the coupling means includes a plurality of pegs coupled to the base, the pegs mating with holes in the first template and the second template.

17. The device of claim 16, wherein the pegs are removably connected to the base.

18. The device of claim 12, wherein the first template and the second template are coupled to each other.

19. The device of claim 18, wherein the first template and the second template are hingedly coupled to each other.

20. The device of claim 12, wherein the first template and the second template have different thicknesses.

21. The device of claim 20, wherein one of the first template and the second template has a thickness of about 0.010 inches.

22. The device of claim 12, wherein one of the first template and the second template includes a grid for aligning a medium.

23. A scoring system, comprising:
a base member with a depression on one side thereof;
a plurality of pegs removably coupled to the base member; and
first and second templates, each of the templates including at least one substantially identical shape in substantially the same position on each of the templates, each of the templates including a plurality of holes for mating with the plurality of pegs, the first template having a different thickness than the second template.

24. The scoring system of claim 23, further comprising a textured plate sized to fit within the depression of the base member.

25. The scoring system of claim 23, wherein the first template and the second template are connected to each other.

26. The scoring system of claim 23, wherein the first template and the second template are removable from the base.

27. The scoring system of claim 23, further comprising a marking instrument for scoring materials placed between the first template and the second template.

28. The scoring system of claim 23, wherein one of the first template and the second template has a thickness of about 0.010 inches.

29. The scoring system of claim 28, wherein the at least one shape on one of the first template and the second template is of a different size than the at least one shape on the other template.

30. The scoring system of claim 29, wherein the other of the first template and the second template has a thickness of about 0.015 inches.

31. The scoring system of claim 23, wherein each shape in one of the first and second templates is about 0.050 inches larger in cross-section than the corresponding shape in the other of the first and second templates.

32. The scoring system of claim 23, wherein one of the first and second templates include a preprinted grid thereon for aligning a medium to be scored.
